(19) United States
(12) Patent Application Publication
(10) Pub. No.: US 2022/0386144 A1
(43) Pub. Date: Dec. 1, 2022

(54) METHOD FOR DETERMINING REFERENCE SIGNAL AND COMMUNICATIONS DEVICE

(71) Applicant: VIVO MOBILE COMMUNICATION CO., LTD., Dongguan (CN)

(72) Inventors: Ang YANG, Dongguan (CN); Peng SUN, Dongguan (CN)

(73) Assignee: VIVO MOBILE COMMUNICATION CO., LTD., Dongguan (CN)

(21) Appl. No.: 17/886,434

(22) Filed: Aug. 11, 2022

Related U.S. Application Data
(63) Continuation of application No. PCT/CN2021/075407, filed on Feb. 5, 2021.

(30) Foreign Application Priority Data
Feb. 12, 2020 (CN) 202010089226.9

(51) Int. Cl. H04W 16/28; H04L 5/00; H04W 74/08

(52) U.S. Cl. CPC H04W 16/28; H04L 5/0051; H04W 74/0833

(57) ABSTRACT

A method for determining a reference signal and a communications device are provided. The method for determining a reference signal includes determining a target Reference Signal (RS) as a RS of a neighboring cell in a case that a first condition is met. The first condition includes any one of the following: first information includes related information of the neighboring cell; or related configuration information of a first object includes related information of the neighboring cell.

### CROSS-REFERENCE TO RELATED APPLICATIONS

This application is a continuation of International Application No. PCT/CN2021/075407, filed on Feb. 5, 2021, which claims priority to Chinese Patent Application No. 202010089226.9 filed on Feb. 12, 2020. The entire contents of each of the above-referenced applications are expressly incorporated herein by reference.

### TECHNICAL FIELD

The present disclosure relates to the field of communications technologies, and in particular to a method for determining a reference signal and a communications device.

### BACKGROUND

In the prior art, beam management and power control can be performed only based on a Reference Signal (RS) of a current cell. In a scenario of mobility or multiple Transmission Reception Points (TRPs), a network usually intends to quickly use a RS of a neighboring cell. However, if the RS of the neighboring cell is to be used at present, cell handover needs to be performed first, which results in a long delay.

### SUMMARY

Embodiments of the present disclosure provide a method for determining a reference signal and a communications device.

The present disclosure is implemented as follows:

According to a first aspect, an embodiment of the present disclosure provides a method for determining a reference signal, including:

determining a target RS as a RS of a neighboring cell in a case that a first condition is met,

where the first condition includes at least one of the following:

first information includes related information of the neighboring cell; and

related configuration information of a first object includes related information of the neighboring cell.

According to a second aspect, an embodiment of the present disclosure provides a communications device, including:

a first determining module, configured to determine a target RS as a RS of a neighboring cell in a case that a first condition is met,

where the first condition includes at least one of the following:

first information includes related information of the neighboring cell; and

related configuration information of a first object includes related information of the neighboring cell.

According to a third aspect, an embodiment of the present disclosure provides a communications device, including a memory, a processor, and a computer program that is stored in the memory and that can be on the processor, where when the computer program is executed by the processor, the steps of the method for determining a reference signal are implemented. The communications device may be a terminal or a network device.

According to a fourth aspect, an embodiment of the present disclosure provides a computer readable storage medium which stores a computer program, where when the computer program is executed by a processor, the steps of the method for determining a reference signal are implemented.

In the embodiments of the present disclosure, the target RS can be determined as the RS of the neighboring cell in a case that the first condition is met. Therefore, the RS of the neighboring cell can be obtained in a case that no cell handover is performed, so that a delay when the RS of the neighboring cell is obtained can be reduced. Further, when cross-cell beam management and power control are implemented, the RS of the neighboring cell can be quickly obtained, which effectively improves system flexibility.

### BRIEF DESCRIPTION OF DRAWINGS

The technical solutions of the embodiments of the present disclosure are described together with accompanying drawings. The following briefly describes the accompanying drawings. Apparently, the accompanying drawings in the following description show merely some embodiments of the present disclosure, and a person of ordinary skill in the art may still derive other drawings from these accompanying drawings without creative efforts.

FIG. 1 is a flowchart of a method for determining a reference signal according to an embodiment of the present disclosure;

FIG. 2 is a schematic structural diagram of a communications device according to an embodiment of the present disclosure;

FIG. 3 is a schematic structural diagram of a terminal according to an embodiment of the present disclosure; and

FIG. 4 is a schematic structural diagram of a network device according to an embodiment of the present disclosure.

### DETAILED DESCRIPTION

The technical solutions of the embodiments of the present disclosure are described together with the accompanying drawings. The following briefly describes the accompanying drawings. Apparently, the accompanying drawings in the following description show merely some embodiments of the present disclosure, and a person of ordinary skill in the art may still derive other drawings from these accompanying drawings without creative efforts.

The term “include” and any other variants in the specification and claims of this application mean to cover the non-exclusive inclusion, for example, a process, method, system, product, or device that includes a list of steps or units is not necessarily limited to those steps or units, but may include other steps or units not expressly listed or inherent to such a process, method, product, or device. In addition, “and/or” used in the description and the claims means at least one of the connected objects. For example, A and/or B represents the following three cases: only A exists, only B exists, and both A and B exist.

It should be noted that a method for determining a reference signal and a communications device provided in the embodiments of the present disclosure may be applied to a wireless communications system. The wireless communications system may be a 5G system, a Long Term Evolution (LTE)/LTE-Advanced (LTE-A) system, or a subsequent evolution communications system.

The wireless communications system in the embodiments of the present disclosure includes a terminal and a network device. The terminal may also be referred to as a terminal device or User Equipment (UE). The terminal may be a terminal side device such as a mobile phone, a tablet personal computer, a laptop computer, a Personal Digital Assistant (PDA), a Mobile Internet Device (MID), a wearable device, or an in-vehicle device. It should be noted that a specific type of the terminal is not limited in embodiments of the present disclosure. The network device may be a base station or a core network. The base station may be a base station of 5G and later versions (for example, a gNB and a 5G NRNB), or a base station in other communications systems (for example, an eNB, a WLAN access point, or other access points). The base station may be referred to as a NodeB, an evolved NodeB, an access point, a Base Transceiver Station (BTS), a radio base station, a radio transceiver, a Basic Service Set (BSS), an Extended Service Set (ESS), a NodeB, an evolved NodeB (eNB), a home NodeB, a home evolved NodeB, a WLAN access point, a Wi-Fi node, or other appropriate terms in the art. Provided that the same technical effects are achieved, the base station is not limited to specific technical vocabulary.

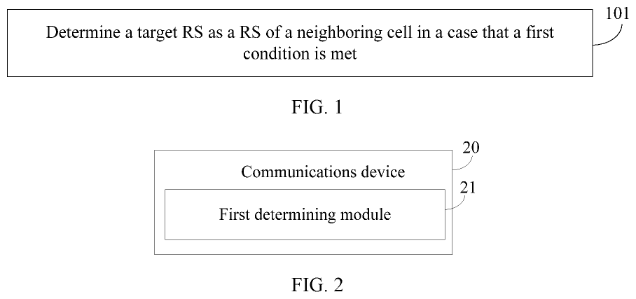

Referring to FIG. 1, FIG. 1 is a flowchart of a method for determining a reference signal according to an embodiment of the present disclosure. The method is applied to a communications device, and the communications device may be a terminal or a network device. As shown in FIG. 1, the method includes the following step.

Step 101: Determine a target RS as a RS of a neighboring cell in a case that a first condition is met.

In some embodiments, the first condition may include any one of the following:

first information includes related information of the neighboring cell; and

related configuration information of a first object includes related information of the neighboring cell.

In this embodiment of the present disclosure, the target RS can be determined as the RS of the neighboring cell in a case that the first condition is met. Therefore, the RS of the neighboring cell can be obtained in a case that no cell handover is performed, so that a delay when the RS of the neighboring cell is obtained can be reduced. Further, when cross-cell beam management and power control are implemented, the RS of the neighboring cell can be quickly obtained, which effectively improves system flexibility.

In some embodiments, the related information of the neighboring cell may include at least one of the following:

an identifier (ID) of the neighboring cell;

ID-related information of the neighboring cell; or

information indicating the neighboring cell.

For example, the ID of the neighboring cell is a Physical Cell Index (PCI). The information indicating the neighboring cell is, for example, the ID indicating the neighboring cell. The ID indicating the neighboring cell can be determined by network high-layer signaling, such as Radio Resource Control (RRC) signaling or a Media Access Control Control Element (MAC CE), and the ID is associated with the neighboring cell.

In some embodiments, the RS of the neighboring cell may include at least one of the following:

a Synchronization Signal Block (Synchronization Signal and PBCH block, SSB), a Channel State Information-Reference Signal (CSI-RS), or a channel Sounding Reference Signal (SRS).

In this embodiment of the present disclosure, for example, the first condition is that the first information includes the related information of the neighboring cell, and the first information can be selected from the following.

(1) The first information may include at least one of Quasi-CoLocation (QCL) information and spatial relation information. Correspondingly, the target RS includes at least one of the following: a RS in the QCL information and a RS in the spatial relation information.

For example, if the ID of the neighboring cell (the ID-related information of the neighboring cell, or the information indicating the neighboring cell) is configured in the QCL information, the RS in the QCL information is the RS of the neighboring cell.

For another example, if the ID of the neighboring cell (the ID-related information of the neighboring cell, or the information indicating the neighboring cell) is configured in the spatial relation information, the RS in the spatial relation information is the RS of the neighboring cell.

For still another example, if the ID of the neighboring cell (the ID-related information of the neighboring cell or the information indicating the neighboring cell) is configured in the QCL information and the spatial relation information, the RS in the QCL information and the spatial relation information is the RS of the neighboring cell.

(2) The first information is Transmission Configuration Indication (TCI) information. Correspondingly, the target RS is a RS in QCL information of the TCI information.

For example, if the ID of the neighboring cell (the ID-related information of the neighboring cell or the information indicating the neighboring cell) is configured in the TCI information, the RS in the QCL information of the TCI information is the RS of the neighboring cell.

In this embodiment of the present disclosure, for example, the first condition is that the related configuration information of the first object includes the related information of the neighboring cell, and the first object may include one of the following situations

(a) The first object may include at least one of the following: a Physical Downlink Control Channel (PDCCH), a Physical Downlink Shared Channel (PDSCH), a SSB, a CSI-RS, a Physical Uplink Control Channel (PUCCH), a Physical Uplink Shared Channel (PUSCH), or a SRS. Correspondingly, the target RS may include at least one of the following: a RS in QCL information of the first object, a RS in TCI information of the first object, or a RS in spatial relation information of the first object.

In some embodiments, the related information of the neighboring cell is not required to be configured in the QCL information of the first object, such as the ID of the neighboring cell, the ID-related information of the neighboring cell, and/or the information indicating the neighboring cell. In some embodiments, the related information of the neighboring cell is not required to be configured in the TCI information of the first object, such as the ID of the neighboring cell, the ID-related information of the neighboring cell, and/or the information indicating the neighboring cell. In some embodiments, the related information of the neighboring cell is not required to be configured in the spatial relation information of the first object, such as the ID of the neighboring cell, the ID-related information of the neighboring cell, and/or the information indicating the neighboring cell.

For example, taking the PDCCH as an example, if the ID of the neighboring cell (or the ID-related information of the neighboring cell or the information indicating the neighboring cell) is configured in related configuration information of the PDCCH, a RS in QCL information, TCI information, and/or in spatial relation information of the PDCCH is the RS of the neighboring cell, that is, a RS of a neighboring cell associated with or indicated by the PDCCH. The related configuration information of the PDCCH may be: PDCCH configuration (PDCCH-Config), PDCCH common configuration (PDCCH-ConfigCommon), and configuration information associated with the PDCCH.

For example, taking the PDSCH as an example, if the ID of the neighboring cell (or the ID-related information of the neighboring cell or the information indicating the neighboring cell) is configured in related configuration information of the PDSCH, a RS in QCL information, TCI information, and/or spatial relation information of the PDSCH is the RS of the neighboring cell, that is, a RS of a neighboring cell associated with or indicated by the PDSCH. The related configuration information of the PDSCH may be: PDSCH configuration (PDSCH-Config), PDSCH common configuration (PDSCH-ConfigCommon), and configuration information associated with the PDSCH.

For another example, taking a downlink RS (such as a SSB or CSI-RS) as an example, if the ID of the neighboring cell (or the ID-related information of the neighboring cell or the information indicating the neighboring cell) is configured in related configuration information of the downlink RS, a RS in QCL information, TCI information, and/or spatial relation information of the downlink RS is the RS of the neighboring cell, that is, a RS of the neighboring cell associated with or indicated by the downlink RS. Related configuration information of the downlink RS may be: CSI measurement configuration (CSI-MeasConfig), CSI report configuration (CSI-ReportConfig), CSI resource configuration (CSI-ResourceConfig), a NZP-CSI-RS resource set (NZP-CSI-RS-Resource Set), a NZP-CSI-RS resource (NZP-CSI-RS-Resource), a CSI-SSB resource set (CSI-SSB-ResourceSet), or configuration information associated with the downlink RS.

For still another example, taking the PUCCH as an example, if the ID of the neighboring cell (or the ID-related information of the neighboring cell or the information indicating the neighboring cell) is configured in related configuration information of the PUCCH, a RS in QCL information, TCI information, and/or spatial relation information of the PUCCH is the RS of the neighboring cell, that is, the RS of the neighboring cell associated with or indicated by the PUCCH. Related configuration information of the PUCCH may be: PUCCH configuration (PUCCH-Config), PUCCH common configuration (PUCCH-ConfigCommon), PUCCH spatial relationship information (PUCCH-SpatialRelationInfo), PUCCH power control (PUCCH-PowerControl), and configuration information associated with the PUCCH.

For yet another example, taking the PUSCH as an example, if the ID of the neighboring cell (or the ID-related information of the neighboring cell or the information indicating the neighboring cell) is configured in related configuration information of the PUSCH, a RS in QCL information, TCI information, and/or spatial relation information of the PUSCH is the RS of the neighboring cell, that is, a RS of a neighboring cell associated with or indicated by the PUSCH. Related configuration information of the PUSCH can be: PUSCH configuration (PUSCH-Config), PUSCH common configuration (PUSCH-ConfigCommon), PUSCH serving cell configuration (PUSCH-ServingCellConfig), PUSCH power control (PUSCH-PowerControl), PUSCH path loss calculation reference RS (PUSCH-PathlossReferenceRS), SRI-PUSCH power control (SRI-PUSCH-PowerControl), and configuration information associated with the PUSCH.

For still yet another example, taking the SRS as an example, if the ID of the neighboring cell (or the ID-related information of the neighboring cell or the information indicating the neighboring cell) is configured in related configuration information of the SRS, a RS in QCL information, TCI information, and/or spatial relation information of the SRS is the RS of the neighboring cell, that is, a RS of a neighboring cell associated with or indicated by the SRS. Related configuration information of the SRS can be: SRS configuration (SRS-Config), a SRS resource set (SRS-Resource Set), a SRS resource (SRS-Resource), SRS spatial relation information (SRS-SpatialRelationInfo), a path loss calculation reference RS (pathlossReferenceRS), and configuration information associated with the SRS.

(b) The first object may include at least one of the following: the PUCCH, PUSCH, SRS, or a Physical Random Access Channel (PRACH). Correspondingly, the target RS is a Path Loss calculation reference Reference Signal (PL RS) of the first object.

In some embodiments, the related information of the neighboring cell is not required to be configured in the PL RS of the first object and a power control parameter associated with the PL S of the first object, such as the ID of the neighboring cell, the ID-related information of the neighboring cell, and/or the information indicating the neighboring cell.

For example, taking the PUCCH as an example, if the ID of the neighboring cell (or the ID-related information of the neighboring cell or the information indicating the neighboring cell) is configured in related configuration information of the PUCCH, a PL RS of the PUCCH is the RS of the neighboring cell, that is, a RS of a neighboring cell associated with or indicated by the PUCCH. The related configuration information of the PUCCH may be: PUCCH configuration (PUCCH-Config), PUCCH common configuration (PUCCH-ConfigCommon), PUCCH spatial relation information (PUCCH-SpatialRelationInfo), PUCCH power control (PUCCH-PowerControl), a PUCCH-path loss calculation reference RS (PUCCH-PathlossReferenceRS), and configuration information associated with the PUCCH.

For another example, taking the PUSCH as an example, if the ID of the neighboring cell (or the ID-related information of the neighboring cell or the information indicating the neighboring cell) is configured in related configuration information of the PUSCH, a PL RS of the PUSCH is the RS of the neighboring cell, that is, a RS of a neighboring cell associated with or indicated by the PUSCH. Related configuration information of the PUSCH can be: PUSCH configuration (PUSCH-Config), PUSCH common configuration (PUSCH-ConfigCommon), PUSCH serving cell configuration (PUSCH-ServingCellConfig), PUSCH power control (PUSCH-PowerControl), PUSCH path loss calculation reference RS (PUSCH-PathlossReferenceRS), SRI-PUSCH power control (SRI-PUSCH-PowerControl), and configuration information associated with the PUSCH.

For still another example, taking the SRS as an example, if the ID of the neighboring cell (or the ID-related information of the neighboring cell or the information indicating the neighboring cell) is configured in related configuration information of the SRS, a PL RS of the SRS is the RS of the neighboring cell, that is, a RS of a neighboring cell associated with or indicated by the SRS. Related configuration information of the SRS can be: SRS configuration (SRS-Config), a SRS resource set (SRS-ResourceSet), a SRS resource (SRS-Resource), SRS spatial relation information (SRS-SpatialRelationInfo), a path loss calculation reference RS (pathlossReferenceRS), and configuration information associated with the SRS.

For yet another example, taking the PRACH as an example, if the ID of the neighboring cell (or the ID-related information of the neighboring cell or the information indicating the neighboring cell) is configured in related configuration information of the PRACH, a PL RS of the PRACH is the RS of the neighboring cell, that is, a RS of a neighboring cell associated with or indicated by the PRACH. Related configuration information of the PRACH may be: random access channel common configuration (RACH-ConfigCommon), random access channel dedicated configuration (RACH-ConfigDedicated), random access channel general configuration (RACH-ConfigGeneric), and configuration information associated with the PRACH.

(c) The first object is at least one of a target object set. The target object set includes at least one of the following: a PDCCH, PDSCH, SSB, CSI-RS, PUCCH, PUSCH, SRS, or PRACH. Correspondingly, the target RS includes at least one of the following: a RS in QCL information of a second object, a RS in TCI information of a second object, a RS in spatial relation information of a second object, or a PL RS of a second object. The second object is associated with the first object.

In an implementation manner, the second object may be an object associated with the first object in the target object set.

In an implementation manner, that the second object is associated with the first object is that the first object schedules the second object.

For example, the first object is the PDCCH, and the second object is the PDSCH, PUCCH, PUSCH, SRS, and PRACH, and then that the first object is associated with the second object may be that the PDCCH schedules the PDSCH, the PUSCH, and the PRACH, and the PUCCH is associated with the PDSCH and the PUSCH.

For another example, a PDCCH resource is associated with the neighboring cell (that is, related information of the neighboring cell is configured in related configuration information of the PDCCH), and then a RS in QCL information, TCI information, spatial relation information, and/or a PL RS of the PDSCH, PUCCH, PUSCH, SRS, and PRACH associated with the PDCCH is a RS of the associated/indicated neighboring cell. In some embodiments, the related information of the neighboring cell, such as the ID of the neighboring cell, the ID-related information of the neighboring cell, and/or the information indicating the neighboring cell, is not required to be configured in the QCL information, TCI information, and spatial relation information of the PDSCH, PUCCH, PUSCH, SRS, and PRACH associated with the PDCCH.

For still another example, a SSB (or CSI-RS, or SRS) is associated with the neighboring cell, for a RS in QCL information, TCI information, spatial relation information, and/or PL RS of some channels or signals (such as at least one of the PDCCH, PDSCH, SSB, CSI-RS, PUCCH, PUSCH, SRS, or PRACH), a RS in the QCL information, TCI information, spatial relation information, and/or the rest of the PL RS of these signals or channels are also a RS of the associated or indicated neighboring cell. In some embodiments, related information of the neighboring cell is not required to be configured in the QCL information, TCI information, spatial relation information, and/or PL RS of these channels or signals, such as the ID of the neighboring cell, the ID-related information of the neighboring cell, and/or information indicating the neighboring cell.

In this embodiment of the present disclosure, in addition to the foregoing manner for determining the RS of the neighboring cell, the RS of the neighboring cell may be further determined based on a default RS. In some embodiments, the method may further include:

determining at least one of the following as the RS of the neighboring cell:

a RS in a list configured by a network device or reported by a terminal; and

a measured RS of the neighboring cell, for example, the measured RS of the neighboring cell may be a RS of the neighboring cell to be measured by the terminal.

In an exemplary implementation manner, the measured RS of the neighboring cell may be a measured RS of the neighboring cell reported by the terminal.

This way, the RS of the neighboring cell is determined based on the default RS, so that signaling overheads and a communication delay can be further reduced.

In an implementation manner, after the network device configures or the terminal reports the list, the RS in the list is the RS of the neighboring cell. When the RS of the neighboring cell is used subsequently, the related information of the neighboring cell is not required to be carried in the related configuration information, such as the ID of the neighboring cell, the ID-related information of the neighboring cell, and/or the information indicating the neighboring cell.

In another implementation manner, if the ID of the neighboring cell (or the ID-related information of the neighboring cell, or the information indicating the neighboring cell) is configured in related configuration information of at least one of the PDCCH, PDSCH, SSB, CSI-RS, PUCCH, PUSCH, SRS, or PRACH, but no RS is configured in its QCL information, TCI information, spatial relation information, and/or PL RS, the reported measured RS of the neighboring cell may be used.

In some embodiments, if multiple measured RSs exist in the neighboring cell, the measured RSs of the neighboring cell meet at least one of the following:

the multiple measured RSs have the best quality, for example, the best quality may be the best Reference Signal Received Power (RSRP), the best Reference Signal Received Quality (RSRQ), or the best Signal to Interference plus Noise Ratio (SINR);

the multiple measured RSs have the largest ID or the smallest ID;

the multiple measured RSs have the highest priority, for example, the SSB has the highest priority, the CSI-RS has the highest priority, or the SRS has the highest priority; or

the multiple measured RSs are selected by the terminal or indicated by the network device.

In some embodiments, the foregoing report may be at least one of the following: a beam report, a Radio Resource Management (RRM) report, or a Radio Link Monitoring (RLM) report.

In some embodiments, the foregoing measured RS may be a measured RS in the neighboring cell.

In this embodiment of the present disclosure, the manner for determining the target RS as the RS of the neighboring cell can be agreed in a protocol, or configured by the network device, for example, configured through high-layer signaling.

Further, the determining the target RS as the RS of the neighboring cell may be activated through signaling from the network device. That is, the network device can issue signaling to the terminal, so that the terminal can know that the foregoing target RS (for example, the RS in the QCL information, the RS in the spatial relation information, or the PL RS) is the RS of the neighboring cell, otherwise, the target RS may be a RS of a current cell. After the network device issues the signaling, the foregoing target RS (such as the RS in the QCL information, the RS in the spatial relation information, or the PL RS) can be also determined as the RS of the neighboring cell, otherwise, the target RS may be the RS of the current cell.

In some embodiments, the signaling issued by the network device may be signaling used to indicate inter-cell Multi-TRP and related signaling. Configuration information of a control resource set (CORESET) belonging to a TRP ID and its associated information may include the ID of the neighboring cell. In some embodiments, the TRP ID may be CORESETPoolIndex.

In an implementation manner, a PCI, PCI-related information, a cell ID, or cell ID-related information of the neighboring cell, or a TRP ID or TRP ID-related information of another TRP can be activated or updated when the network device issues the signaling. Signaling in which the ID-related information is located may be at least one of the following.

(1) High-layer signaling: for example, cell group configuration (CellGroupConfig), secondary cell configuration (SpCellConfig), reconfiguration with synchronization (ReconfigurationWithSync), serving cell common configuration (ServingCellConfigCommon), serving cell configuration (ServingCellConfig), and associated signaling;

(2) Physical-layer signaling: for example, CSI measurement configuration (CSI-MeasConfig), CSI report configuration (CSI-ReportConfig), CSI resource configuration (CSI-ResourceConfig), a NZP-CSI-RS resource set (NZP-CSI-RS-ResourceSet), a NZP-CSI-RS resource (NZP-CSI-RS-Resource), a CSI-SSB resource set (CSI-SSB-ResourceSet), SRS configuration (SRS-Config), a SRS resource set (SRS-ResourceSet), a SRS Resource (SRS-Resource), PDCCH configuration (PDCCH-Config), PDSCH configuration (PDSCH-Config), PUCCH configuration (PUCCH-Config), PUSCH configuration (PUSCH-Config), and associated signaling

Referring to FIG. 2, FIG. 2 is a schematic structural diagram of a communications device according to an embodiment of the present disclosure. The communications device may be a terminal or a network device. As shown in FIG. 2, the communications device 20 includes:

a first determining module 21, configured to determine a target RS as a RS of a neighboring cell in a case that a first condition is met.

The first condition includes at least one of the following:

first information includes related information of the neighboring cell; and

related configuration information of a first object includes related information of the neighboring cell.

In some embodiments, the first information includes at least one of QCL information and spatial relation information; and

the target RS includes at least one of the following: a RS in the QCL information and a RS in the spatial relation information.

In some embodiments, the first information is TCI information; and

the target RS is a RS in QCL information of the TCI information.

In some embodiments, the first object includes at least one of the following: a PDCCH, PDSCH, SSB, CSI-RS, PUCCH, PUSCH, or SRS; and

the target RS includes at least one of the following: a RS in QCL information of the first object, a RS in TCI information of the first object, or a RS in spatial relation information of the first object.

In some embodiments, the first object includes at least one of the following: a PUCCH, PUSCH, SRS, or PRACH; and the target RS is a PL RS of the first object.

In some embodiments, the first object is at least one of a target object set, and the target object set includes the following: a PDCCH, PDSCH, SSB, CSI-RS, PUCCH, PUSCH, SRS, and PRACH; and

the target RS includes at least one of the following: a RS in QCL information of a second object, a RS in TCI information of a second object, a RS in spatial relation information of a second object, or a PL RS of a second object.

The second object is associated with the first object. In some embodiments, the method further includes:

a second determining module, configured to determine at least one of the following as the RS of the neighboring cell:

a RS in a list configured by a network device or reported by a terminal; and

a measured RS of the neighboring cell.

In some embodiments, if multiple measured RSs exist in the neighboring cell, the measured RSs of the neighboring cell meet at least one of the following:

the multiple measured RSs have the best quality;

the multiple measured RSs have the largest ID or the smallest ID;

the multiple measured RSs have the highest priority; or

the multiple measured RSs are selected by the terminal or indicated by the network device.

In some embodiments, the related information of the neighboring cell includes at least one of the following:

an ID of the neighboring cell;

ID-related information of the neighboring cell; or

information indicating the neighboring cell.

In some embodiments, the RS of the neighboring cell includes at least one of the following:

an SSB, CSI-RS, or SRS.

In some embodiments, the determining the target RS as the RS of the neighboring cell is activated through signaling from the network device.

The communications device 20 provided according to the embodiments of the present disclosure can implement processes implemented in the method embodiment shown in FIG. 1, and a same effect can be achieved. To avoid repetition, details are not described herein again.

An embodiment of the present disclosure further provides a communications device, including a processor, a memory, and a computer program that is stored in the memory and that can be run on the processor, where when the computer program is executed by the processor, each process of the method embodiment shown in FIG. 1 can be implemented, and a same effect can be achieved. To avoid repetition, details are not described herein again. In some embodiments, the communications device may be a terminal or a network device.

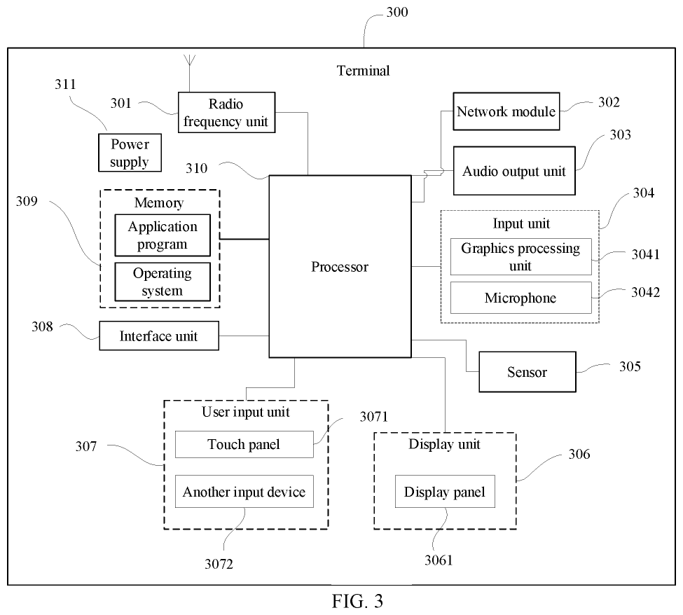

FIG. 3 is a schematic diagram of a hardware structure of a terminal for implementing the embodiments of the present disclosure. The terminal 300 includes but is not limited to components such as a radio frequency unit 301, a network module 302, an audio output unit 303, an input unit 304, a sensor 305, a display unit 306, a user input unit 307, an interface unit 308, a memory 309, a processor 310, and a power supply 311. A person skilled in the art may understand that a structure of the terminal shown in FIG. 3 does not constitute a limitation on the terminal, and the terminal may include more or fewer components than those shown in the figure, or combine some components, or have different component arrangements. In this embodiment of the present disclosure, the terminal includes but is not limited to a mobile phone, a tablet computer, a laptop computer, a palmtop computer, an in-vehicle terminal, a wearable device, a pedometer, and the like.

The processor 310 is configured to: determine a target RS as a RS of a neighboring cell in a case that a first condition is met. The first condition includes any one of the following: first information includes related information of the neighboring cell, and related configuration information of a first object includes related information of the neighboring cell.

The terminal 300 provided according to the embodiments of the present disclosure may implement processes implemented in the method embodiment shown in FIG. 1, and a same effect can be achieved. To avoid repetition, details are not described herein again.

It should be understood that in this embodiment of the present disclosure, the radio frequency unit 301 may be configured to receive and transmit information, or receive and transmit signals during a call. In some embodiments, the radio frequency unit transmits downlink data to the processor 310 for processing after receiving the downlink data from a base station; and transmits uplink data to the base station. Usually, the radio frequency unit 301 includes but is not limited to an antenna, at least one amplifier, a transceiver, a coupler, a low noise amplifier, a duplexer, and the like. In addition, the radio frequency unit 301 may communicate with a network and another device through a wireless communication system.

The terminal provides wireless broadband Internet access to a user through the network module 302, for example, helps the user receive and send e-mails, browse web pages, access streaming media, and the like.

The audio output unit 303 may convert audio data received by the radio frequency unit 301 or the network module 302 or stored in the memory 309 into an audio signal and output the audio signal as a sound. In addition, the audio output unit 303 may further provide an audio output (for example, a call signal received voice, or a message received voice) related to a specific function implemented by the terminal 300. The audio output unit 303 includes a loudspeaker, a buzzer, a telephone receiver, and the like.

The input unit 304 is configured to receive an audio signal or a video signal. The input unit 304 may include a Graphics Processing Unit (GPU) 3041 and a microphone 3042. The graphics processing unit 3041 is used to process image data of a static picture or a video obtained by an image capturing device (for example, a camera) in a video capturing mode or an image capturing mode. A processed image frame may be displayed on the display unit 306. The image frame processed by the graphics processing unit 3041 may be stored in the memory 309 (or another storage medium) or sent by using the radio frequency unit 301 or the network module 302. The microphone 3042 may receive sound and can process such sound into audio data. The processed audio data may be converted in a call mode into a format that can be sent by the radio frequency unit 301 to a mobile communication base station for outputting.

The terminal 300 further includes at least one sensor 305, for example, a light sensor, a motion sensor, and another sensor. In some embodiments, the light sensor includes an ambient light sensor and a proximity sensor. The ambient light sensor may adjust luminance of the display panel 3061 based on brightness of ambient light. The proximity sensor may turn off the display panel 3061 and/or backlight when the terminal 300 is moved to an ear. As a type of the motion sensor, an accelerometer sensor can detect magnitude of acceleration in each direction (generally, on three axes), and may detect magnitude and a direction of gravity when being static. The accelerometer sensor may be used for recognizing a terminal gesture (for example, portrait and landscape orientation switching, a related game, or magnetometer posture calibration), a function related to vibration recognition (for example, a pedometer or a strike), or the like. The sensor 305 may further include a fingerprint sensor, a pressure sensor, an iris sensor, a molecular sensor, a gyroscope, a barometer, a hygrometer, a thermometer, an infrared sensor, and the like. Details are not described herein.

The display unit 306 is configured to display information input by a user or information provided for a user. The display unit 306 may include the display panel 3061, and the display panel 3061 may be configured in a form of a Liquid Crystal Display (LCD), an Organic Light-Emitting Diode (OLED), or the like.

The user input unit 307 may be configured to receive input digit or character information and generate key signal input related to user setting and function control of the terminal. In some embodiments, the user input unit 307 includes a touch panel 3071 and another input device 3072. The touch panel 3071 is also referred to as a touchscreen, and may collect a touch operation performed by a user on or near the touch panel 3071 (for example, an operation performed by a user on or near the touch panel 3071 by using any proper object or accessory, for example, a finger or a stylus). The touch panel 3071 may include two parts: a touch detection apparatus and a touch controller. The touch detection apparatus detects a touch location of the user, detects a signal brought by the touch operation, and sends the signal to the touch controller. The touch controller receives touch information from the touch detection apparatus, converts the touch information into touch point coordinates, sends the touch point coordinates to the processor 310, and receives and executes a command sent by the processor 310. In addition, the touch panel 3071 may be implemented as a resistive type, a capacitive type, an infrared type, a surface acoustic wave type, or the like. The user input unit 307 may include other input devices 3072 in addition to the touch panel 3071. In some embodiments, the another input device 3072 may include but is not limited to: a physical keyboard, function keys (for example, a volume control key and an on/off key), a trackball, a mouse, or a joystick. Details are not described herein.

Further, the touch panel 3071 may cover the display panel 3061. When detecting the touch operation on or near the touch panel 3071, the touch panel 3071 transmits the touch operation to the processor 310 to determine a type of a touch event, and then the processor 310 provides corresponding visual output on the display panel 3061 based on the type of the touch event. In FIG. 3, the touch panel 3071 and the display panel 3061 are used as two independent components to implement input and output functions of the terminal. However, in some embodiments, the touch panel 3071 and the display panel 3061 may be integrated to implement the input and output functions of the terminal. This is not specifically limited herein.

The interface unit 308 is an interface connecting an external apparatus to the terminal 300. For example, the external apparatus may include a wired or wireless headset port, an external power supply (or a battery charger) port, a wired or wireless data port, a memory card port, a port for connecting an apparatus having an identification module, an audio input/output (I/O) port, a video I/O port, an earphone port, and the like. The interface unit 308 may be configured to receive input (for example, data information and power) from the external apparatus and transmit the received input to one or more elements in the terminal 300, or may be configured to transmit data between the terminal 300 and the external apparatus.

The memory 309 may be configured to store a software program and various pieces of data. The memory 309 may mainly include a program storage area and a data storage area. The program storage area may store an operating system, an application program required by at least one function (for example, a sound play function or an image display function), and the like. The data storage area may store data (for example, audio data or an address book) or the like created based on use of a mobile phone. In addition, the memory 309 may include a high-speed random access memory, and may further include a nonvolatile memory, for example, at least one magnetic disk storage device, a flash storage device, or another volatile solid-state storage device.

The processor 310 is a control center of the terminal, and connects all parts of the entire terminal by using various interfaces and lines. By running or executing a software program and/or a module stored in the memory 309 and invoking data stored in the memory 309, the processor performs various functions of the terminal and data processing, to perform overall monitoring on the terminal. The processor 310 may include one or more processing units. In some embodiments, the processor 310 may be integrated with an application processor and a modem processor. The application processor mainly processes an operating system, a user interface, an application program, and the like. The modem processor mainly processes wireless communication. It can be understood that the modem processor may not be integrated into the processor 310.

The terminal 300 may further include a power supply 311 (such as a battery) that supplies power to each component. In some embodiments, the power supply 311 may be logically connected to the processor 310 by using a power management system, to implement functions such as charging, discharging, and power consumption management by using the power management system.

In addition, the terminal 300 may further include some function modules not shown, and details are not described herein.

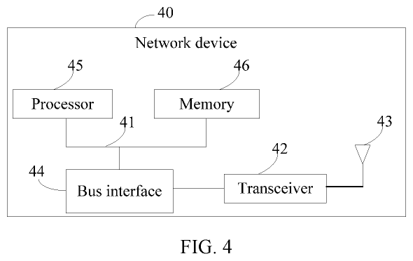

Referring to FIG. 4, FIG. 4 is a schematic diagram of a hardware structure of a network device for implementing the embodiments of the present disclosure. The network device 40 includes but is not limited to a bus 41, a transceiver 42, an antenna 43, a bus interface 44, a processor 45, and a memory 46.

In this embodiment of the present disclosure, the network device 40 further includes a computer program that is stored in the memory 46 and that can be run on the processor 45, where when the computer program is executed by the processor 45, the following steps are implemented:

determining a target RS as a RS of a neighboring cell in a case that a first condition is met.

The first condition includes at least one of the following:

first information includes related information of the neighboring cell; and

related configuration information of a first object includes related information of the neighboring cell.

The transceiver 42 is configured to receive and send data under the control of the processor 45.

The network device 40 provided according to the embodiments of the present disclosure may implement various processes implemented by the method embodiment shown in FIG. 1, and a same effect can be achieved. To avoid repetition, details are not described herein again.

In FIG. 4, for a bus architecture (represented by a bus 41), the bus 41 may include any quantity of interconnecting buses and bridges, and the bus 41 interconnects various circuits of one or more processors represented by the processor 45 and a memory represented by a memory 46. The bus 41 may further link together various other circuits, such as a peripheral device, a voltage regulator, and a power management circuit. These are all well known in the art. Therefore, this specification provides no further description. The bus interface 44 provides an interface between the bus 41 and the transceiver 42. The transceiver 42 may be one component or may be multiple components, for example, multiple receivers and transmitters, and provide a unit that is configured to communicate with various other apparatuses on a transmission medium. Data processed by the processor 45 is transmitted on a wireless medium by using the antenna 43. Further, the antenna 43 further receives data and transmits the data to the processor 45.

The processor 45 is responsible for managing the bus 41 and general processing, and may further provide various functions, including timing, peripheral interfacing, voltage regulation, power management, and another control function. The memory 46 may be configured to store data used by the processor 45 when performing an operation.

An embodiment of the present disclosure further provides a computer-readable storage medium. The computer-readable storage medium stores a computer program, and when a processor executes the computer program, each process in the method embodiment shown in FIG. 1 can be implemented, and a same technical effect can be achieved. To avoid repetition, details are not described herein again. The computer-readable storage medium is, for example, a Read-Only Memory (ROM), a Random Access Memory (RAM), a magnetic disk, an optical disc, or the like.

It should be noted that, in this specification, the terms “include”, “comprise”, or any of their variants are intended to cover a non-exclusive inclusion, such that a process, a method, an article, or an apparatus that includes a list of elements not only includes those elements but also includes other elements that are not expressly listed, or further includes elements inherent to such process, method, article, or apparatus. In the absence of more restrictions, an element defined by the statement “including a . . . ” does not preclude the presence of other identical elements in the process, method, article, or apparatus that includes the element.

By means of the foregoing description of the embodiments, a person skilled in the art may clearly understand that the method in the foregoing embodiments may be implemented by software in addition to a necessary universal hardware platform. The method in the foregoing embodiments may also be implemented by hardware. However, in many cases, the former is an embodiment. Based on such understanding, the technical solutions of the present disclosure essentially or the part contributing to the prior art may be implemented in a form of a software product. The computer software product is stored in a storage medium (such as a ROM/RAM, a magnetic disk, or an optical disc), and includes several instructions for instructing a terminal (which may be a mobile phone, a computer, a server, an air conditioner, a network device, or the like) to perform the method described in the embodiments of the present disclosure.

The embodiments of the present disclosure are described above with reference to the accompanying drawings, but the present disclosure is not limited to the foregoing specific implementation manners. The foregoing specific implementation manners are merely exemplary instead of restrictive. Under enlightenment of the present disclosure, a person of ordinary skill in the art may make many forms without departing from the objective of the present disclosure and the protection scope of claims, all of which fall within the protection of the present disclosure.

1. A method for determining a reference signal, comprising:
determining a target Reference Signal (RS) as a RS of a neighboring cell in a case that a first condition is met,
wherein the first condition comprises at least one of the following:
first information comprises related information of the neighboring cell; or
related configuration information of a first object comprises related information of the neighboring cell.

2. The method according to claim 1, wherein the first information comprises at least one of Quasi-CoLocation (QCL) information and spatial relation information; and
the target RS comprises at least one of the following: a RS in the QCL information or a RS in the spatial relation information.

3. The method according to claim 1, wherein the first information is Transmission Configuration Indication (TCI) information; and
the target RS is a RS in QCL information of the TCI information.

4. The method according to claim 1, wherein the first object comprises at least one of the following: a Physical Downlink Control Channel (PDCCH), a Physical Downlink Shared Channel (PDSCH), a Synchronization Signal Block (SSB), a Channel State Information-Reference Signal (CSI-RS), a Physical Uplink Control Channel (PUCCH), a Physical Uplink Shared Channel (PUSCH), or a channel Sounding Reference Signal (SRS); and
the target RS comprises at least one of the following: a RS in QCL information of the first object, a RS in TCI information of the first object, or a RS in spatial relation information of the first object.

5. The method according to claim 1, wherein the first object comprises at least one of the following: a PUCCH, PUSCH, SRS, or Physical Random Access Channel (PRACH); or
the target RS is a Path Loss calculation reference Reference Signal (PL RS) of the first object.

6. The method according to claim 1, wherein the first object is at least one of a target object set, wherein the target object set comprises the following: a PDCCH, PDSCH, SSB, CSI-RS, PUCCH, PUSCH, SRS, or PRACH; and
the target RS comprises at least one of the following: a RS in QCL information of a second object, a RS in TCI information of a second object, a RS in spatial relation information of a second object, or a PL RS of a second object; and
the second object is associated with the first object.

7. The method according to claim 1, further comprising:
determining at least one of the following as the RS of the neighboring cell:
a RS in a list configured by a network device or reported by a terminal; or
a measured RS of the neighboring cell.

8. The method according to claim 7, wherein when multiple measured RSs exist in the neighboring cell, the measured RSs of the neighboring cell meet at least one of the following:
the multiple measured RSs have the best quality;
the multiple measured RSs have the largest ID or the smallest ID;
the multiple measured RSs have the highest priority; or
the multiple measured RSs are selected by the terminal or indicated by the network device.

9. The method according to claim 1, wherein the related information of the neighboring cell comprises at least one of the following:
an ID of the neighboring cell;
ID-related information of the neighboring cell; or
information indicating the neighboring cell.

10. The method according to claim 1, wherein the RS of the neighboring cell comprises at least one of the following:
an SSB, CSI-RS, or SRS.

11. The method according to claim 1, wherein the determining a target RS as a RS of a neighboring cell is activated through signaling from a network device.

12. A communications device, comprising: a memory having a computer program stored therein; and a processor, wherein the computer program, when is executed by the processor, causes the processor to perform a method for determining a reference signal, comprising:
determining a target Reference Signal (RS) as a RS of a neighboring cell in a case that a first condition is met,
wherein the first condition comprises at least one of the following:
first information comprises related information of the neighboring cell; or
related configuration information of a first object comprises related information of the neighboring cell.

13. The communications device according to claim 12, wherein the first information comprises at least one of Quasi-CoLocation (QCL) information and spatial relation information; and
the target RS comprises at least one of the following: a RS in the QCL information or a RS in the spatial relation information.

14. The communications device according to claim 12, wherein the first information is Transmission Configuration Indication (TCI) information; and
the target RS is a RS in QCL information of the TCI information.

15. The communications device according to claim 12, wherein the first object comprises at least one of the following: a Physical Downlink Control Channel (PDCCH), a Physical Downlink Shared Channel (PDSCH), a Synchronization Signal Block (SSB), a Channel State Information-Reference Signal (CSI-RS), a Physical Uplink Control Channel (PUCCH), a Physical Uplink Shared Channel (PUSCH), or a channel Sounding Reference Signal (SRS); and
the target RS comprises at least one of the following: a RS in QCL information of the first object, a RS in TCI information of the first object, or a RS in spatial relation information of the first object.

16. The communications device according to claim 12, wherein the first object comprises at least one of the following: a PUCCH, PUSCH, SRS, or Physical Random Access Channel (PRACH); or
the target RS is a Path Loss calculation reference Reference Signal (PL RS) of the first object.

17. The communications device according to claim 12, wherein the first object is at least one of a target object set, wherein the target object set comprises the following: a PDCCH, PDSCH, SSB, CSI-RS, PUCCH, PUSCH, SRS, or PRACH; and
the target RS comprises at least one of the following: a RS in QCL information of a second object, a RS in TCI information of a second object, a RS in spatial relation information of a second object, or a PL RS of a second object; and
the second object is associated with the first object.

18. The communications device according to claim 1, wherein
the related information of the neighboring cell comprises at least one of the following:
an ID of the neighboring cell;
ID-related information of the neighboring cell; or
information indicating the neighboring cell.

19. The communications device according to claim 18, wherein the RS of the neighboring cell comprises at least one of the following:
an SSB, CSI-RS, or SRS.

20. A non-transitory computer readable storage medium, storing a computer program, wherein the computer program, when executed by a processor, causes the processor to perform a method for determining a reference signal, comprising:
determining a target Reference Signal (RS) as a RS of a neighboring cell in a case that a first condition is met,
wherein the first condition comprises at least one of the following:
first information comprises related information of the neighboring cell; or
related configuration information of a first object comprises related information of the neighboring cell.
